(19) United States
(12) Patent Application Publication
(10) Pub. No.: US 2002/0059594 A1
(43) Pub. Date: May 16, 2002

(54) Configurable information ticker for interactive television and enhanced television

(76) Inventors: Gary Rasmussen, Parker, CO (US); Joe Hassell, Westminster, CO (US); Joseph Saib, Pacifica, CA (US); Brian Sedlak, Highlands Ranch, CO (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/878,615

(22) Filed: Jun. 11, 2001

Related U.S. Application Data
(60) Provisional application No. 60/222,048, filed on Jul. 31, 2000.

(51) Int. Cl. G06F 3/00

(52) U.S. Cl. 725/37

(57) ABSTRACT

A system and method for modifying and displaying ticker data information to a user. The method of displaying data through an information ticker comprises receiving programming data from a remote source, displaying the programming data to a user as an information ticker and providing a user interface adapted to modify the extent that the programming data is displayed to the user. An enhanced television content delivery system for delivering ticker data comprises a device coupled to a communications link wherein the device is operative to receive the ticker data via the communications link. The device comprises a processor configured to filter the ticker data in accordance with a user supplied parameter.

The present application claims priority to U.S. provisional application No. 60/222,048, filed Jul. 31, 2000, which is hereby incorporated by reference.

### FIELD OF THE INVENTION

The present invention pertains to interactive and enhanced television and, more particularly, to information displays in interactive and enhanced television environments.

### BACKGROUND OF THE INVENTION

Conventionally, scrolling text and/or graphics displays (i.e., on-screen “tickers”) are used to provide television viewers with various information, such as stock quotes, news reports, sports scores, weather and traffic reports, etc. However, known techniques for providing such information tickers in the enhanced and interactive television environments do not permit viewers to configure ticker display format or ticker content. Viewers are thus bound to the format and content dictated by a service provider. Consequently, there is a need for improved methods and apparatus for providing information tickers in the interactive and enhanced television space.

### SUMMARY OF THE INVENTION

A method of displaying data through an information ticker comprises receiving programming data from a remote source, displaying the programming data to a user as an information ticker and providing a user interface adapted to modify the extent that the programming data is displayed to the user.

In another aspect, an enhanced television content delivery system for delivering ticker data comprises a device coupled to a communications link wherein the device is operative to receive the ticker data via the communications link. The device comprises a processor configured to filter the ticker data in accordance with a user supplied parameter.

In a further aspect, a method of method of displaying an information ticker on a television, comprises collecting ticker data from a data source, filtering the ticker data according to a configuration parameter supplied by a user, and constructing the information ticker using the filtered ticker data.

Numerous other embodiments and aspects of the invention will become evident hereinafter from the following description, drawings, and claims.

### BRIEF DESCRIPTION OF THE DRAWINGS

The drawings illustrate both the design and utility of the preferred embodiments of the present invention, wherein:

FIG. 1 depicts an exemplary television distribution system in which a configurable information ticker constructed in accordance with the present invention can be implemented;

FIG. 2 depicts an exemplary enhanced television information ticker constructed in accordance with the present invention;

FIGS. 3 and 4 depict an exemplary main ticker configuration screen constructed in accordance with the present invention;

FIGS. 5-13 depict exemplary auxiliary ticker configuration screens constructed in accordance with the present invention; and

FIG. 14 is a flow diagram depicting steps in an exemplary ticker configuration process in accordance with the present invention.

### DETAILED DESCRIPTION

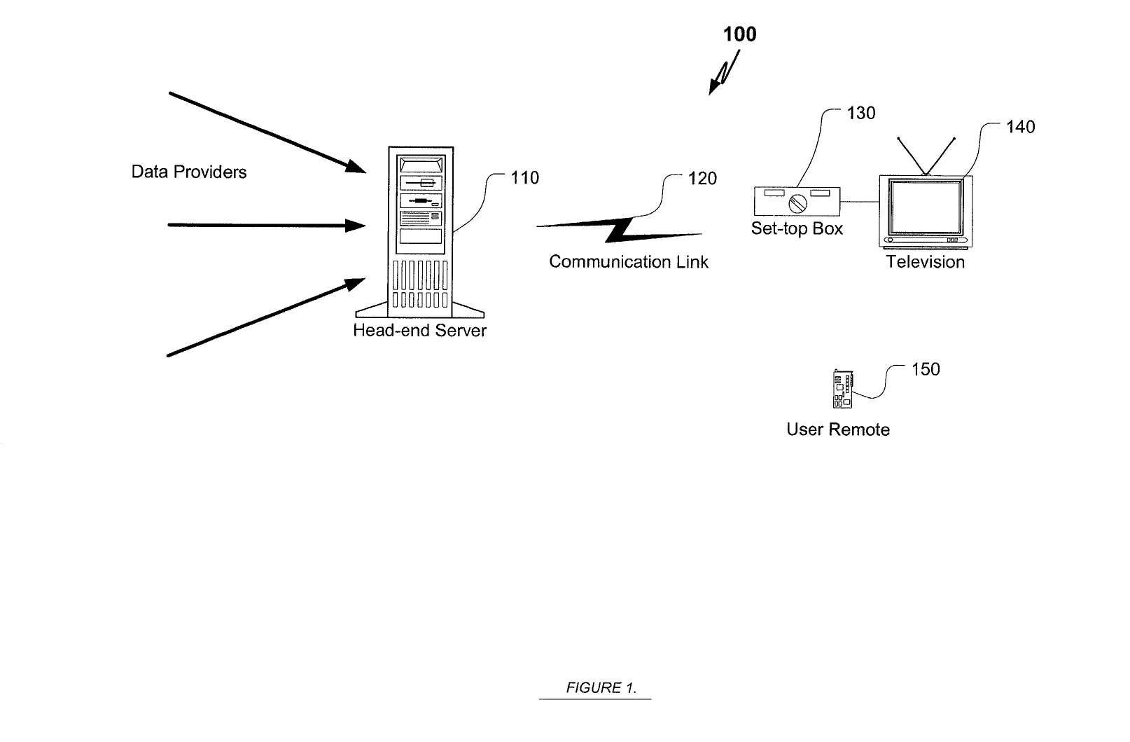

FIG. 1 depicts an exemplary television system 100 in which embodiments of the present invention can be implemented. As shown, the exemplary system 100 includes a head-end server 110, a communications link 120, a set-top box 130, a television 140 and a user remote control 150. In operation, the head-end server 110 provides television programming to the set-top box 130, via the communications link 120 (e.g., a standard cable or satellite television delivery system). The set-top box 130 then converts the incoming programming information into a format appropriate for input to the television 140, and the television viewer can control operation of the set-top box 130 and/or the television 140 via the user remote control 150.

For enhanced and/or interactive television applications, information ticker data can be collected at the head-end server 110 (e.g., from various commercial data providers via ftp and/or HTTP over the Internet, dedicated lines, or dial-up) and passed on to the set-top box 130 along with the television programming information. One or more information tickers can then be displayed on the television (e.g., superimposed on the television image) at the discretion of the viewer. Conventionally, however, the viewer has no control over the content or format of the information tickers. In other words, once the viewer has subscribed to a television channel that contains one or more ticker services, he or she cannot adjust the look of, or the data in, the tickers.

Embodiments of the invention permit a user to adjust both the data content and display format of an information ticker. According to exemplary embodiments, ticker data is categorized into major and minor data areas, each of which can be selected for display at the discretion of the viewer. For example, major data areas can include headline news, stock quotes, sports scores, traffic and weather, etc., and each major data area can have a number of associated minor data areas. For example, the headline news area can include minor data areas for national news, business news, sports news, local news and/or entertainment, and the stock quotes area can include minor data areas for the NYSE, NASDAQ and/or AMEX indices and/or individual stocks specified by stock call letters. Additionally, the sports scores area can include minor data areas for pro sports generally and/or specific leagues (e.g., NBA, NHL, NFL, MLB and/or USPGA) by team and/or player, and the traffic and weather area can include minor data areas for traffic reports in the city where the head-end server is located and/or prevailing regional and local weather conditions. Major and minor data areas can be modified (added or deleted) as dictated by regional requirements.

With respect to display format, embodiments of the invention permit a user to configure an information ticker as either a single-layer or multiple-layer ticker. If the ticker is configured as a single layer (deck), all the major and minor data areas that have been selected can be chained together and displayed one after another. For example, a user can configure the ticker as a single deck, and then select headline news with national news and sports news and stock quotes with the NASDAQ index and a single preferred stock. In such case, when the ticker is toggled on, the single-deck ticker displays the national news followed immediately by sports news, the NASDAQ stock quotes, and finally the single preferred stock quote.

Alternatively, if the ticker is configured to include multiple decks, the number of decks can be set equal to the number of major data areas the user has selected. The minor data areas within each major data area can then be chained together and displayed one after another. The decks can be stacked upon one another and color coded to provide distinction. Using the same selected areas as in the single-deck example provided above, when the ticker is toggled on, a double-deck ticker can display the national news followed immediately by sports news in a top deck, and the NASDAQ stock quotes followed by the particular stock quote in a bottom deck.

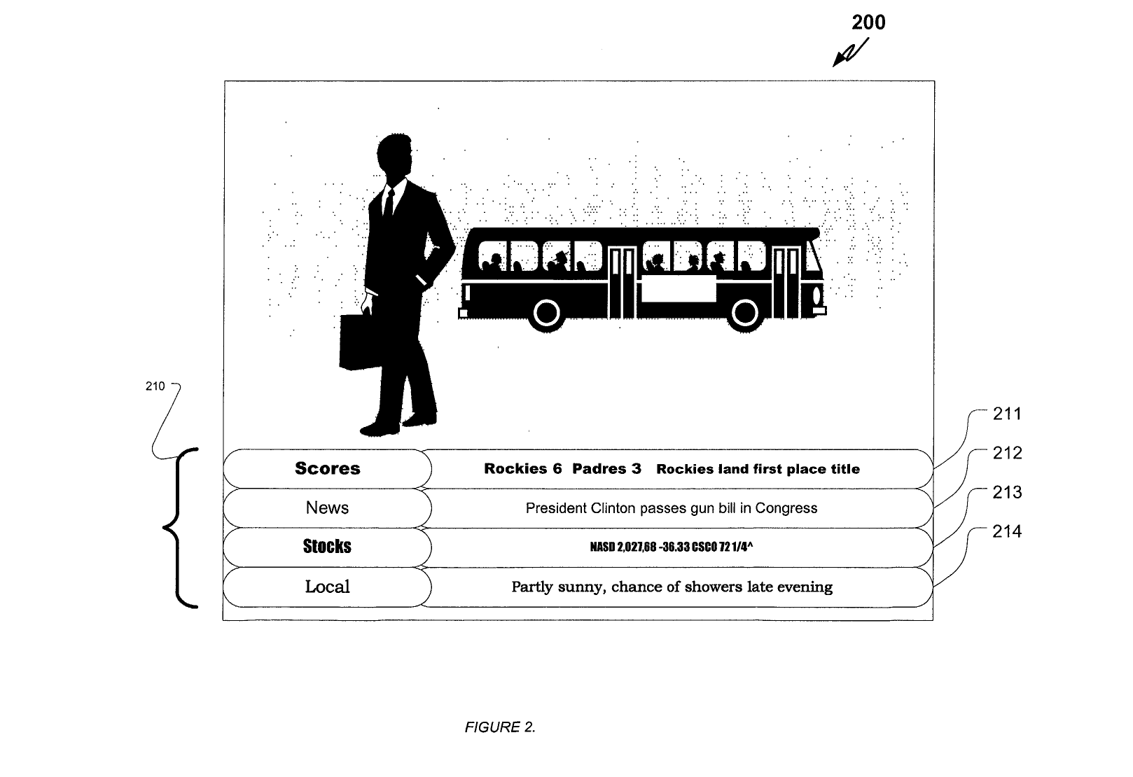

By way of example, FIG. 2 depicts a television image 200 including a four-layer information ticker 210 superimposed on an ordinary television image. It is noted that the embodiment described in conjunction with FIGS. 2-13 is only an example and numerous variations on the format of the information display are contemplated. For instance, additional levels of information can be added to each layer, and the actual content of each layer can be modified. As shown in FIG. 2, the ticker 210 includes four vertically stacked layers 211, 212, 213, 214 corresponding, respectively, to the major data areas of sports scores, headline news, stock quotes and traffic/weather.

In addition to selecting between single and multiple decks, embodiments of the invention permit a user to position the ticker at different locations on the television screen and/or select the speed with which data changes within each deck. Additionally, the user can select among data update/refresh options for each deck (e.g., scrolling data horizontally across each deck as described above, shifting up or down from a displayed line of data to a next line of data within each deck, or fading from a displayed line of data into a next line of data within each deck).

To provide the above described content and format configuration capabilities, embodiments of the invention permit the television user to access a ticker configuration program for activating and deactivating ticker data areas and/or adjusting ticker display attributes. An exemplary ticker configuration program is activated when the user presses a “hot” key (e.g., the “A” key or a menu key on a standard set-top box, or a similar function key on a remote control keypad) and presents the television viewer with a series of configuration screens including options (e.g., check boxes or other visual selection controls) for ticker content and format adjustment. Such a configuration program can be implemented, for example, by way of Java scripts running on a set-top box configured to support third-party application programming. Once the viewer has selected a particular ticker configuration using the configuration menus, the ticker data provided to the head-end server by the commercial data providers is filtered at the set-top and presented to the viewer in accordance with that configuration.

According to an exemplary embodiment, a data-receptacle, database or other storage mechanism is established at the server side of the communications link 120 in order to manipulate incoming ticker information. Since commercial data providers use pre-determined formats to deliver data, templates congruent with such formats are used, according to the embodiment, to re-format the data so that all of it is consistent and more readily stored in the data receptacle and utilized by the configurable information ticker. Server-side algorithms and processes are provided to obtain information from sources which require that data be “pulled” and to accept information from sources which “push” data, as will be appreciated by those of skill in the art.

The server-side storage mechanism can be run in conjunction with the access and retrieval processes to facilitate unattended, automatic data access and retrieval from the providers. During these processes, the data can be re-packaged and stored in the server-side data receptacle. Additionally, optimization algorithms can be used to retrieve data from the data receptacle and send it to the delivery medium 120 for efficient transmission to the set-top box. The above described server side functionality can be incorporated within the head-end server 110, or a dedicated server can be provided for the data-receptacle (including all code needed to implement the above described data storage, access, retrieval and optimization).

According to the exemplary embodiment, filtering of ticker data in accordance with the prevailing user-specified ticker configuration is accomplished on the client side (e.g., via code running on the set-top box 130). Additionally, available memory-resident data space on the set-top box 130 can be used to cache streaming data to fuel the information ticker. Usage of the memory-resident data space can be implemented via a database, a flat-file structure or other data storage methods. Also, data updating algorithms can be used to update parts of the memory-resident data space so that specific data, such as stock quotes, can be updated more often than relatively slow-changing data, such as news headlines.

Note that the above described distribution of functionality between the server and client sides of the communications link 120 is exemplary and can be varied as appropriate in view of other design considerations. For example, the user configuration and/or information filtering processes can be run on the server side. Doing so, however, requires two-way communication between the server and the set-top box (i.e., to pass configuration parameters input by the user at the set-top back to the configuration program/information filter at the server). Advantageously, the above described embodiment (i.e., configuration programming and ticker information filtering at the set-top) requires only one-way communication from the server to the set-top.

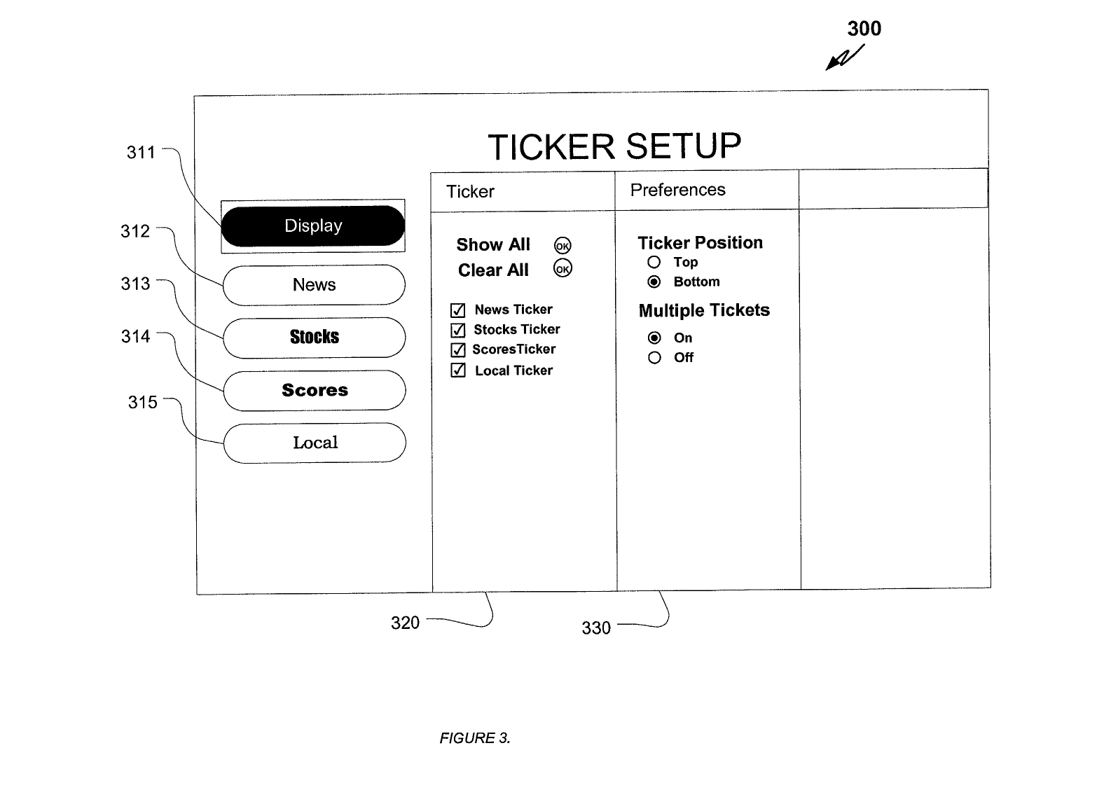

FIGS. 3-13 depict ticker configuration screens generated by an exemplary ticker configuration program according to the invention. Using the exemplary configuration program, a user can select or clear any or all of a number of available major and minor data areas by selecting them individually or by selecting a control that globally selects or globally clears all available areas simultaneously. If a major data area is cleared, settings for the minor data areas within the major data area can remain intact so that the user can easily toggle the major data area without having to reset configurations for the corresponding minor data areas.

FIG. 3 depicts a main ticker configuration screen 300 according to an embodiment of the invention. Such a configuration screen is displayed, for example, on the television 140 where a television viewer presses a particular key on the set-top box 130 or the user remote control 150. As shown, the main configuration screen includes five primary push buttons 311,312,313, 314, 315, as well as first and second selection columns 320, 330. The first primary push button 311 corresponds to the main configuration screen 300 itself, while the remaining primary push buttons 312, 313, 314, 315 correspond to the major data areas headline news, stock quotes, sports scores and local traffic and weather, respectively. On the main configuration screen 300, the first selection column 320 provides the user with four check boxes corresponding to four major data areas, and thus permits the viewer to select and deselect each of the four major data areas individually. A virtually infinite number of data areas, subjects or information stations can be incorporated into the systems and the configuration screen 300. Additionally, the first selection column 320 includes a show all button and a clear all button, so that the viewer can select or deselect all four major data areas simultaneously. The second selection column 330 includes push buttons which permit the viewer to position the ticker at either the top or bottom of the viewing screen, as well as push buttons which permit the viewer to select either a single-deck or a multi-deck ticker display.

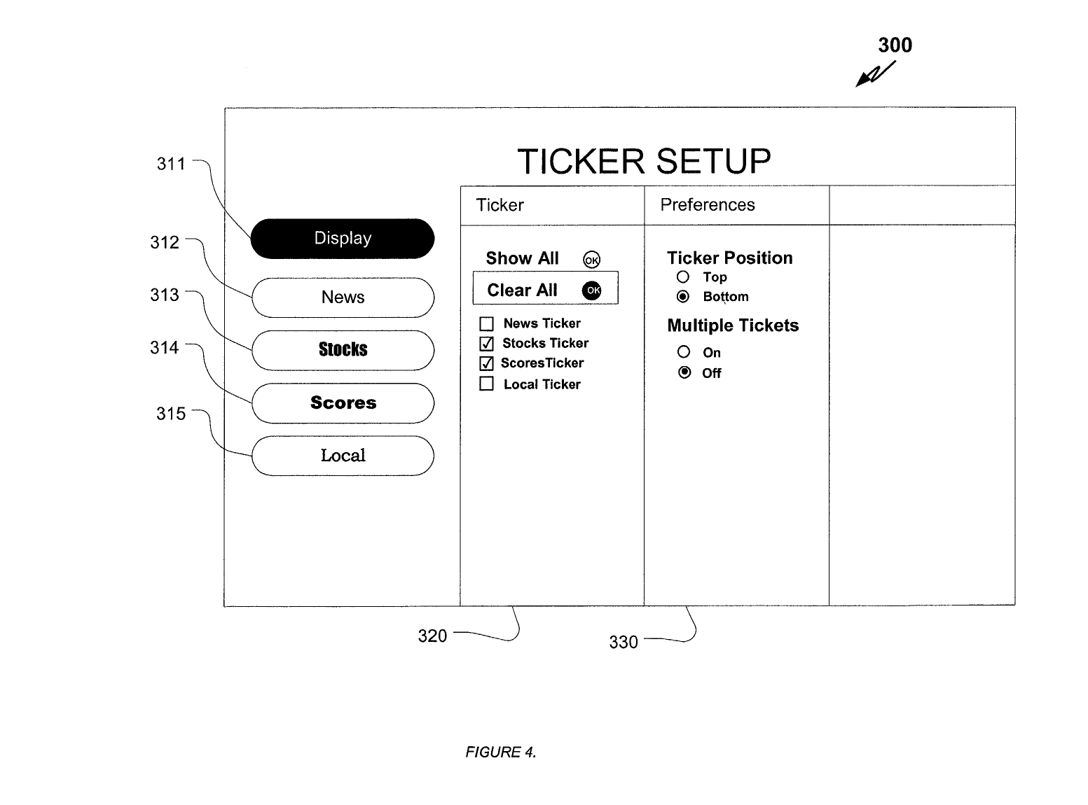

To access items on the main configuration screen 300, the user can for example press up-arrow, down-arrow, left-arrow and right-arrow buttons on the user remote control 150 to highlight a particular button or check box (as shown in FIG. 3, the display push button 311 is highlighted originally), and then press a select key, such as OK, on the remote 150 to toggle or select the highlighted item. Alternately, the remote control can take the form of a joystick or other handheld device. By way of example, FIG. 4 depicts a scenario in which the viewer has selected the display button 311 (shown depressed in FIG. 4) and then highlighted and selected the clear all button in the first selection column 320 to deselect all four major data areas (as indicated by the fact that all four check boxes in the first selection column 320 are shown empty).

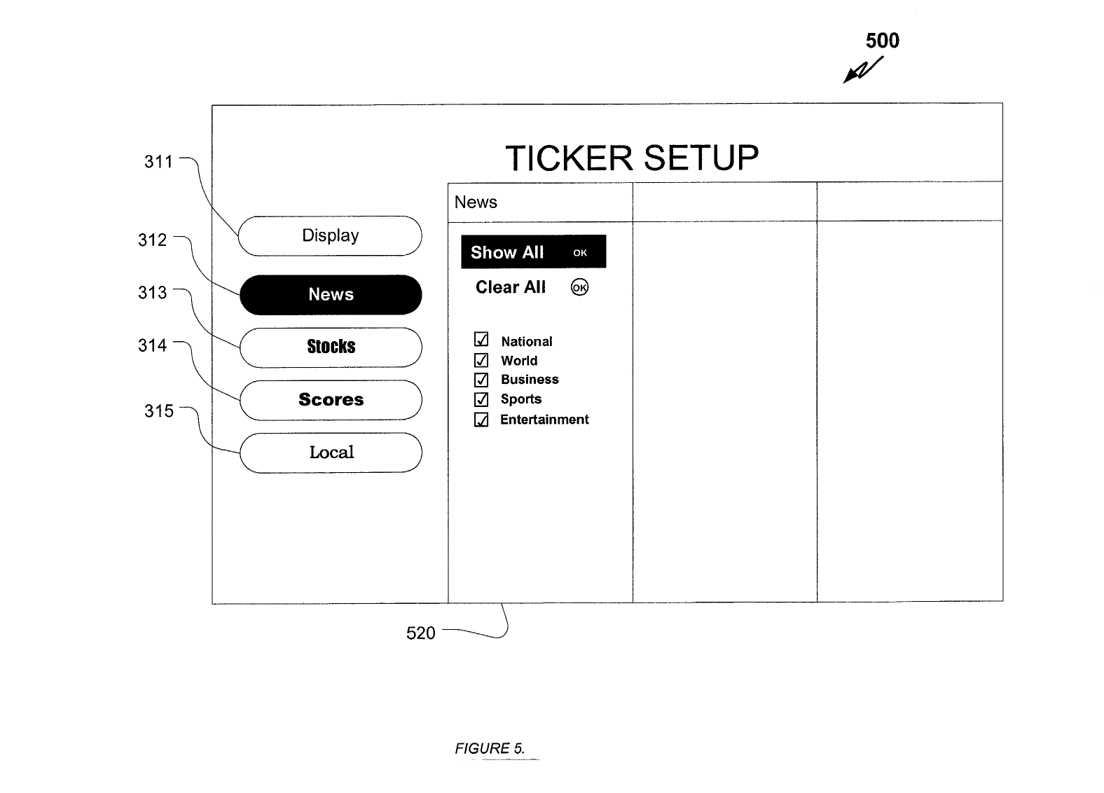

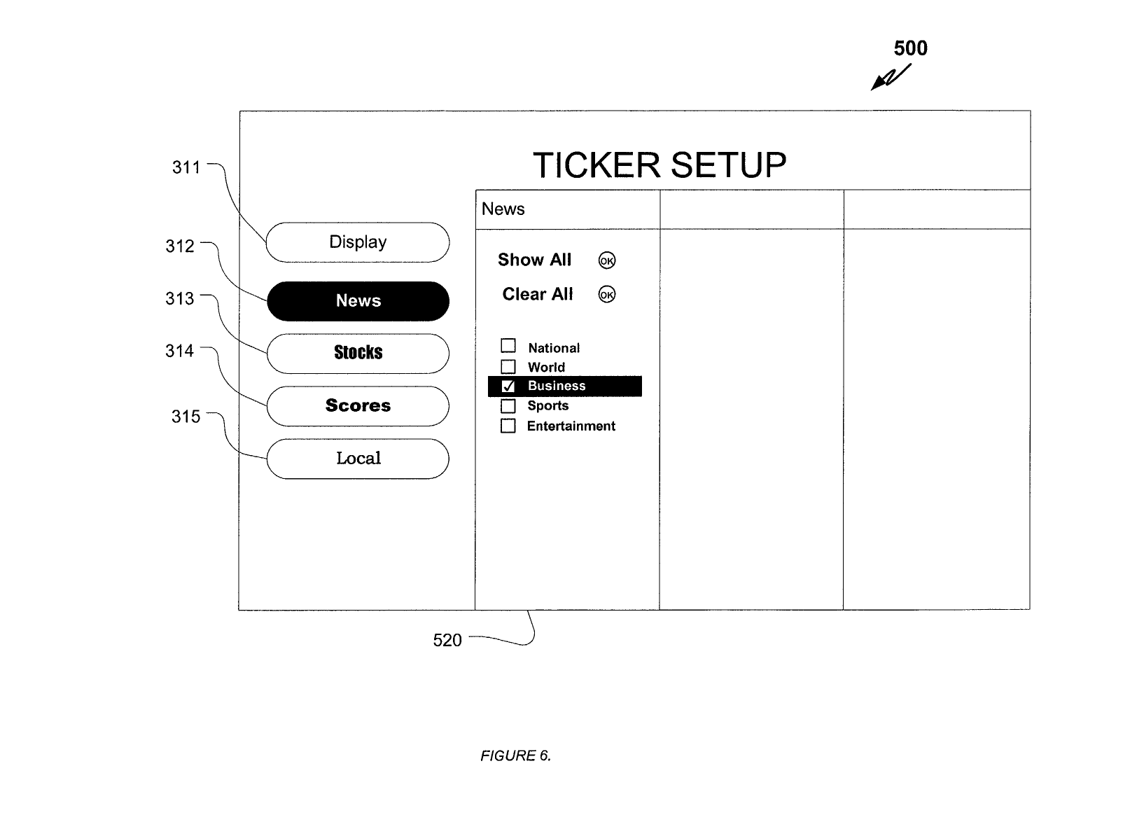

FIG. 5 depicts a news area configuration screen 500 which appears, for example, where the viewer selects the headline news button 312 on the main configuration screen 300. As shown, the news area configuration screen 500 includes the primary push buttons 311, 312, 313, 314, 315 and a news area selection column 520. The news area selection column 520 includes five individually selectable check boxes, corresponding to the minor news data areas of national news, world news, business news, sports news and entertainment news. The news area selection column 520 also includes a show all button and a clear all button so that all of the minor news data areas can be selected or deselected simultaneously. FIG. 6 depicts a scenario in which a viewer has chosen to display only business news within the main news area.

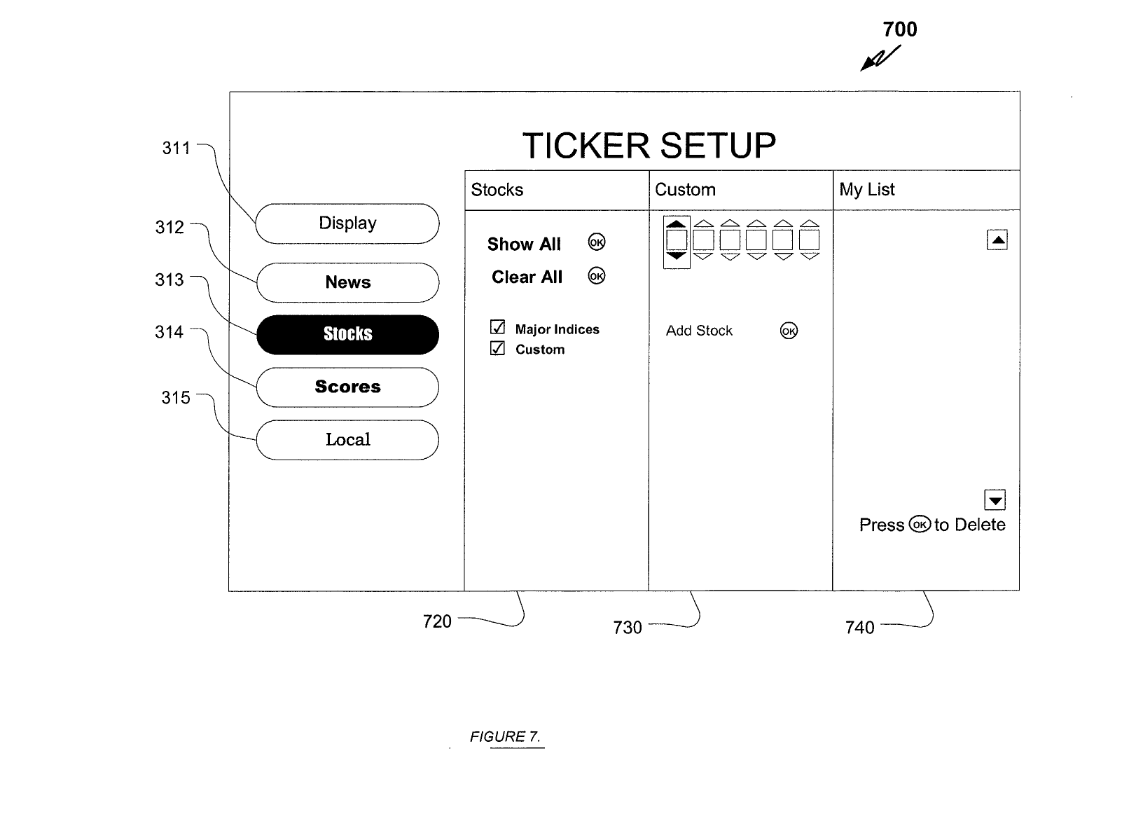

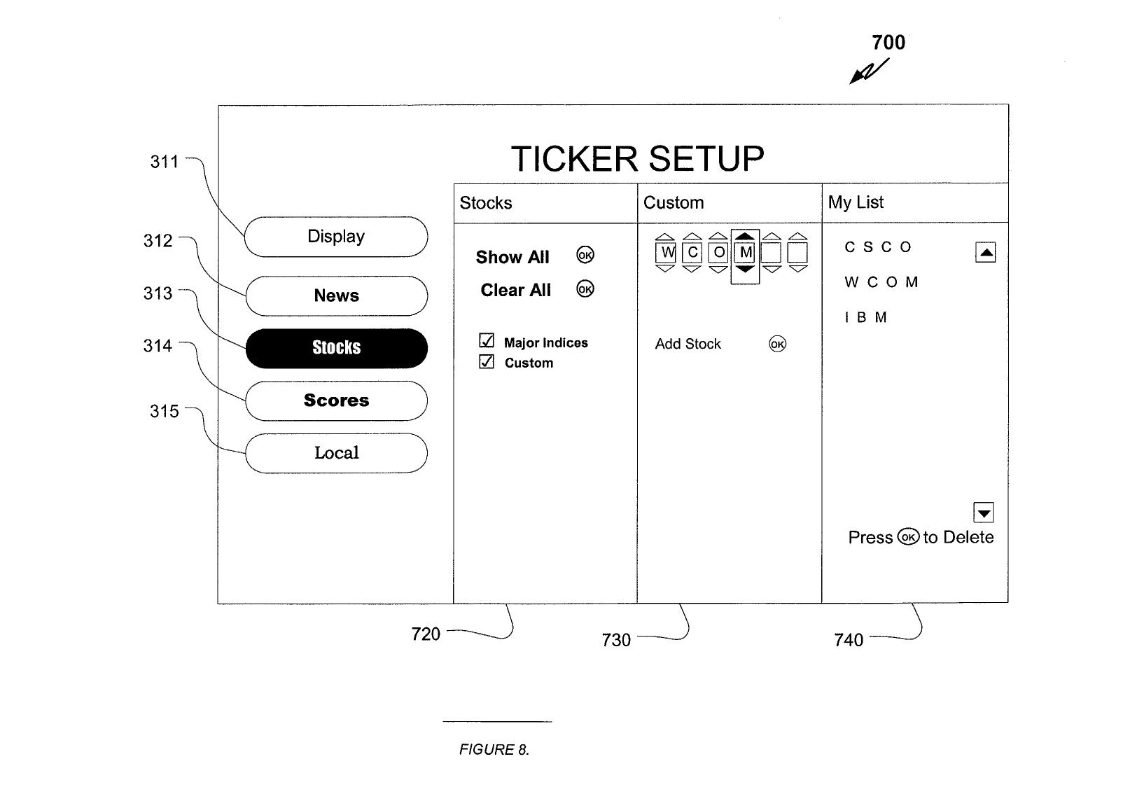

FIG. 7 depicts a stock quotes configuration screen 700 which appears, for example, upon the viewer selecting the stock quotes button 313 on the main configuration screen 300 (or on the news area configuration screen 500). As shown, the stock quotes configuration screen 700 includes the primary push buttons 311, 312, 313, 314, 315, first and second stock selection columns 720, 730 and a display list column 740. The first stock selection column 720 includes two individually selectable check boxes, corresponding to the minor stock quotes data areas of major indices (e.g., NYSE, NASDAQ, AMEX) and custom stocks (e.g., specific user-selected stocks). The first stock selection column 720 also includes a show all button and a clear all button so that both of the minor stock quotes data areas can be selected or deselected simultaneously. The second stock selection column 730 includes a series of scroll boxes which the viewer can use to specify a particular stock by its call letters. The second stock selection column 730 also includes an add stock button so that the viewer can add a specified stock to a list of prevailing (i.e., currently selected) custom stocks shown in the display list column 740. The display list column 740 includes a delete button so that prevailing custom stocks can be deleted from the list. FIG. 8 depicts a scenario in which a viewer has chosen to display both major indices and custom stocks (note both boxes checked in the first stock selection column 720). In FIG. 8, the display list column 740 indicates three prevailing custom stocks (call letters CSCO, WCOM and IBM), and the second stock selection column 730 indicates that custom stock WCOM has been most recently added to the display list.

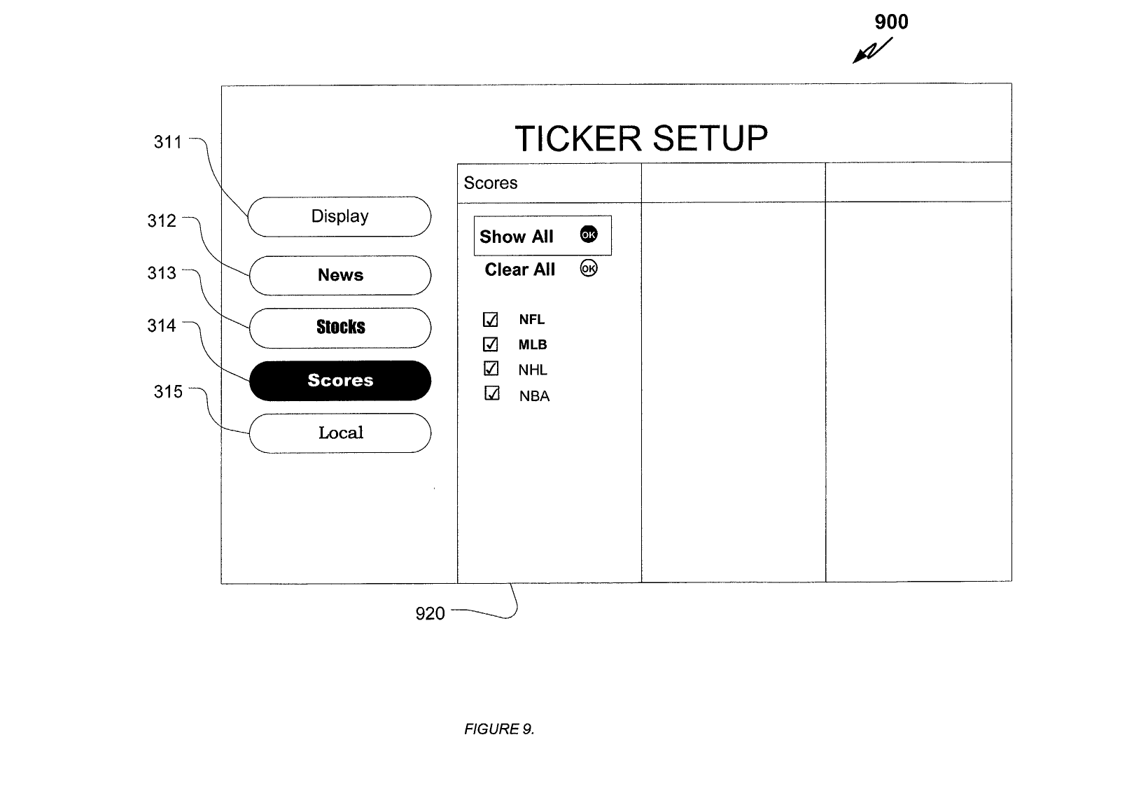

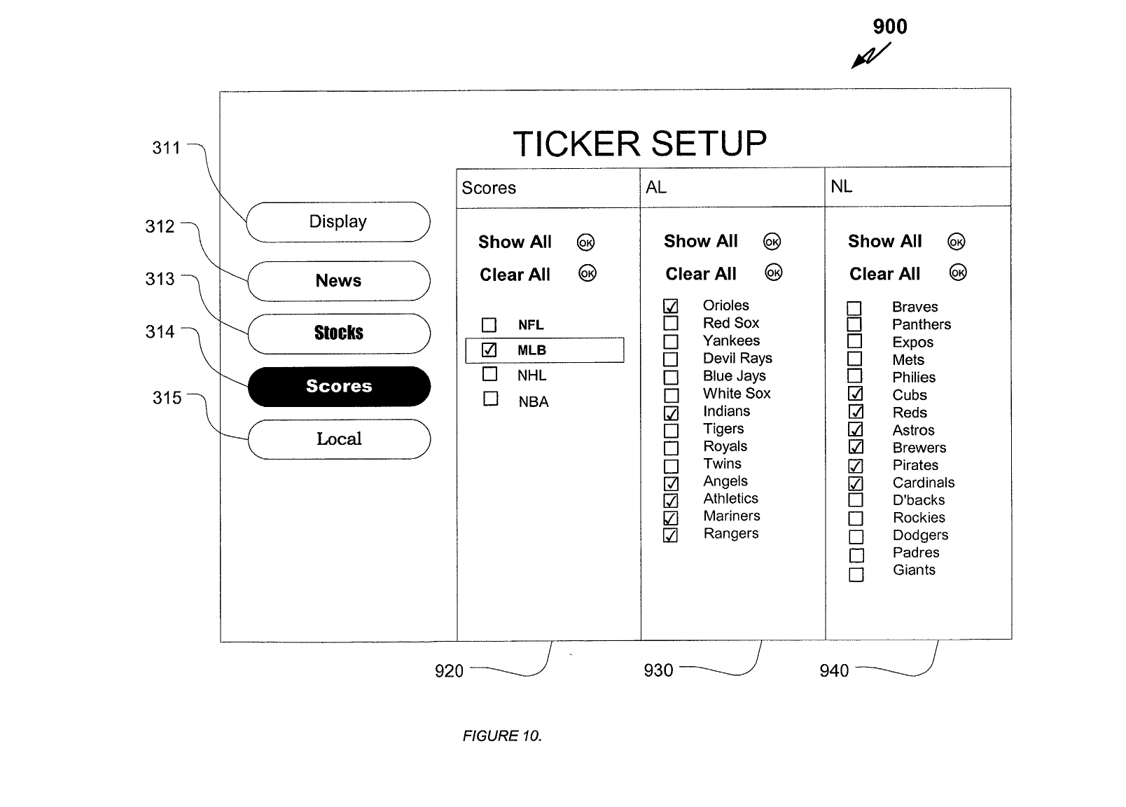

FIG. 9 depicts a sports scores configuration screen 900 which would appear, for example, upon the viewer selecting the sports scores button 314 on the main configuration screen 300 (or on the news area configuration screen 500 or the stock quotes configuration screen 700). As shown, the sports scores configuration screen 900 includes the primary push buttons 311, 312, 313, 314, 315 and a sports scores selection column 920. The sports scores selection column 920 includes four individually selectable check boxes, corresponding to the minor sports scores data areas of National Football League, Major League Baseball, National Hockey League and National Basketball Association. The first sports scores selection column 920 also includes a show all button and a clear all button so that all of the minor sports scores data areas can be selected or deselected simultaneously. FIG. 10 depicts a scenario in which a viewer has chosen to display only Major League Baseball. In FIG. 10, display list columns 930, 940 provide individually selectable check boxes for specific teams within Major League Baseball. Each display list column also includes a select all button and a clear all button for user convenience. It will be understood that other minor sports scores data areas (e.g., NFL, NHL, NBA, USPGA, etc.) can be specified similarly by specific team and/or player.

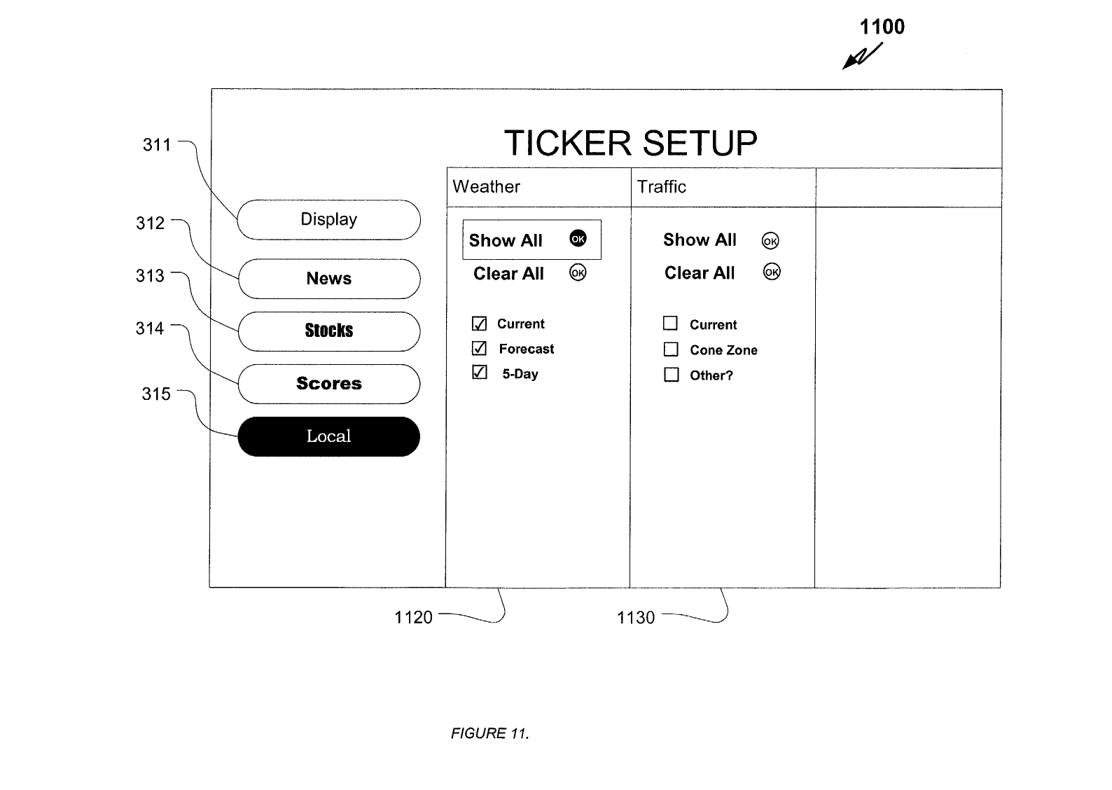

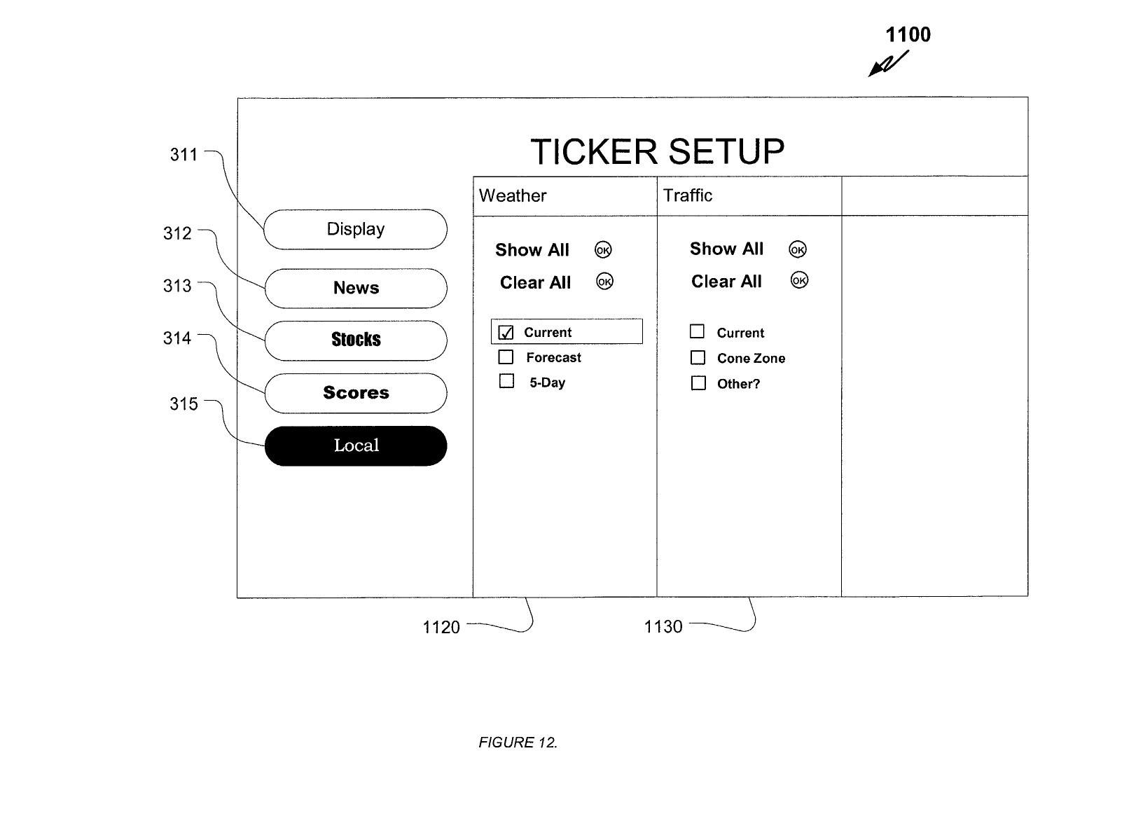

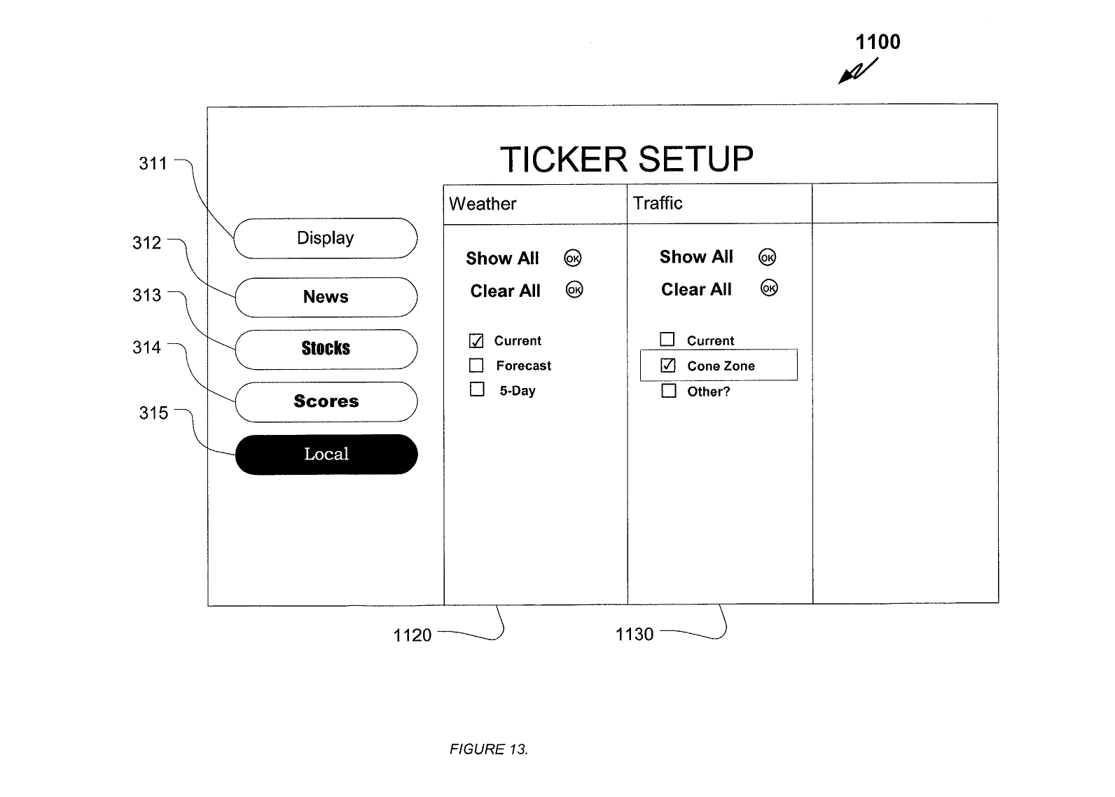

FIG. 11 depicts a local weather and traffic configuration screen 1100 which would appear, for example, upon the viewer selecting the local button 315 on the main configuration screen 300 (or on the other major data area configuration screens 500, 700, 900). As shown, the weather and traffic configuration screen 1100 includes the primary push buttons 311, 312, 313, 314, 315, a weather selection column 1120 and a traffic selection column 1130. The weather selection column 1120 includes three individually selectable check boxes, corresponding to the minor weather data areas of current, forecast and 5-day outlook, and the traffic selection column 1130 includes three individually selectable check boxes, corresponding to the minor traffic data areas of current, cone zone (i.e., a particular local traffic zone) and other (e.g., a particular road or intersection, etc.). Each of the weather and traffic selection columns 1120, 1130 also includes a show all button and a clear all button so that all of the weather or traffic minor data areas can be selected or deselected simultaneously. FIG. 12 depicts a scenario in which a viewer has chosen to display only the current weather, and FIG. 13 depicts a scenario in which a viewer has chosen to display the current weather and a particular traffic zone.

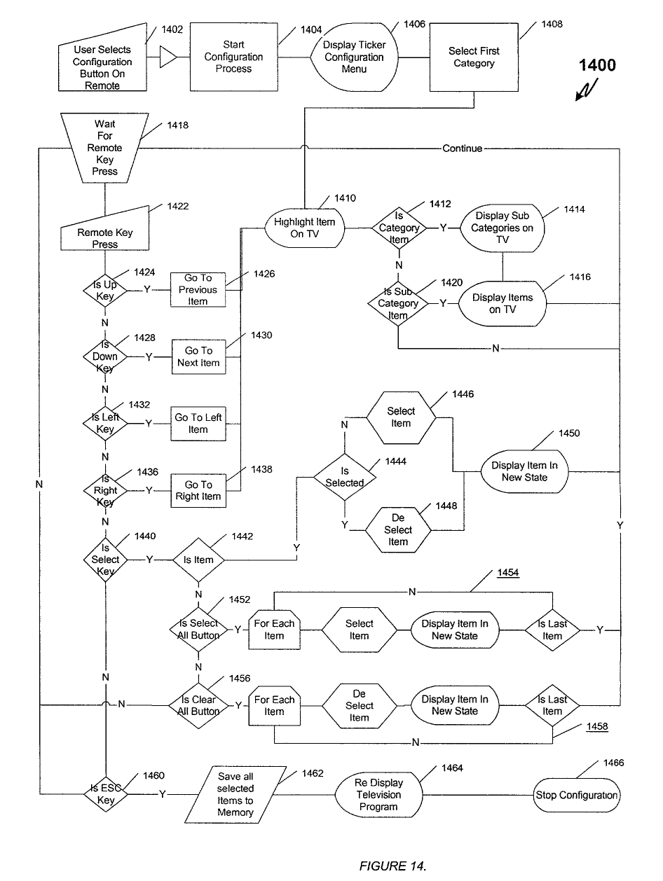

FIG. 14 depicts an exemplary general configuration process 1400 for generating configuration screens such as those shown in FIGS. 3-13. The process of FIG. 14 can be implemented, for example, via Java scripts running on a programmable set-top box such as model No. DCT-5000 manufactured by the General Instrument Company. As shown, the exemplary process 1400 starts at step 1402 when the television viewer activates the configuration process, for example by pressing a hot key on the set-top box 130 or on the user remote control 150. Thereafter, the configuration process starts at step 1404, and a configuration menu is displayed on the television 140 at step 1406. Upon the user selecting a first category at step 1408 (e.g., by pressing up, down, left, right and select keys on the set top box 130 or on the user remote control 150), the selected category is displayed on the television at step 1410.

Then, at step 1412, a determination is made as to whether the selected item is a main category (e.g., a main data area). If so, then the corresponding sub-categories (e.g., minor data areas) are displayed on the television at step 1414, items corresponding to the minor categories are displayed on the television at step 1416, and the process then waits for additional user input at step 1418. Returning to step 1412, if a determination is made that the selected item is not a main category, then a determination is made at step 1420 as to whether the selected item is a sub-category (i.e., minor data area). If so, then the items corresponding to the selected minor data area are displayed on the television at step 1416, and the process waits for additional user input at step 1418. If the selected item is neither a main category nor a sub-category, then the process proceeds directly to step 1418 to await further user input.

Upon the user pressing an additional key at step 1422, a determination is made at step 1424 as to whether the pressed key is an up-arrow key. If so, then a previous item on the presently displayed configuration screen is highlighted at step 1426, and processing returns to step 1410. If the pressed key is not an up-arrow key, then a determination is made at step 1428 as to whether the pressed key is a down-arrow key. If so, then a next item on the presently displayed configuration screen is highlighted at step 1430, and processing returns to step 1410. If the pressed key is not a down-arrow key, then a determination is made at step 1432 as to whether the pressed key is a left-arrow key. If so, then a nearest-left item is highlighted on the presently displayed configuration screen at step 1434, and processing returns to step 1410. If the pressed key is not a left-arrow key, then a determination is made at step 1436 as to whether the pressed key is a right-arrow key. If so, then a nearest-right item on the currently displayed configuration screen is highlighted at step 1438, and processing returns to step 1410.

If the pressed key is not an up-arrow, down-arrow, left-arrow or right-arrow key, then a determination is made at step 1440 as to whether the pressed key is a select key. If so, then a determination is made at step 1442 as to whether the presently highlighted item is a discreet, lowest level item (e.g., a check box). If so, then a determination is made at step 1444 as to whether the item is presently selected, and the item is toggled and displayed in its new state at steps 1446, 1448 and 1450 (and processing returns to step 1418 to await further user input). If the item selected at step 1442 is not a lowest level item, then a determination is made at step 1452 as to whether the selected item is a select-all button. If so, then every lowest level item in the category corresponding to the select-all button is selected and displayed as such at step 1454, and processing returns to step 1418 to await further user input. If it is determined at step 1452 that the selected item is not a select-all button, then a determination is made at step 1456 as to whether the selected item is a clear-all button. If so, then each item in the category corresponding to the selected clear-all button is deselected and displayed as such at step 1458, and processing returns to step 1418 to await further user input. If it is determined at step 1456 that the selected item is neither a show all button nor a clear-all button, then processing returns directly to step 1418 to await further user input.

Returning to step 1440, if it is determined that the pressed key is not a select key, then a determination is made at step 1460 as to whether the pressed key is an escape key. If not, then processing returns directly to step 1418 to await further user input (i.e., the pressed key was an invalid key for the configuration program). However, if the pressed key is an escape key (indicating that the user wishes to exit the configuration program), then all items selected during the configuration process are saved at step 1462 (e.g., in memory within the set-top box 130), ordinary television programming resumes at step 1464, and the configuration process stops at step 1466. The information saved is then applied to the ticker decks when they are activated.

Those of skill in the art will appreciate that the above described embodiments are provided by way of illustration only, and that numerous equivalent embodiments are contemplated herein. For example, although not explicitly shown in the configuration screens of FIGS. 3-13, additional configuration options are readily included (e.g., adjustment of the speed with which data changes in each ticker deck, the update/refresh style used within each ticker deck, etc.).

Although the present invention has been described and illustrated in the above description and drawings, it is understood that this description is by example only and that numerous changes and modifications can be made by those skilled in the art without departing from the true spirit and scope of the invention. The invention, therefore, is not to be restricted, except by the following claims and their equivalents.

What is claimed is:

1. A method of displaying data through an information ticker, comprising:
receiving enhanced television programming data from a remote source in a substantially unmodified form;
displaying the programming data to a user as an information ticker; and
providing a user interface adapted to modify the extent that the programming data is displayed to the user.

2. The method of claim 1, wherein the remote source is a video broadcaster.

3. The method of claim 1, further comprising obtaining a configuration parameter from the user through the user interface.

4. The method of claim 3, wherein obtaining a configuration parameter from the user comprises presenting a configuration menu to the user, the configuration menu enabling the user to select from a number of information ticker configuration options.

5. The method of claim 1, wherein the user interface is a hand-held device.

6. The method of claim 1, wherein the user interface is a remote control device.

7. The method of claim 1, wherein the user interface is a keyboard.

8. A method of displaying an information ticker on a television, comprising:
collecting ticker data from a data source;
filtering the ticker data according to a configuration parameter supplied by a user; and
constructing the information ticker using the filtered ticker data.

9. The method of claim 8, wherein the ticker data is substantially unmodified when collected from the data source.

10. The method of claim 8, wherein filtering the ticker data according to a configuration parameter supplied by a user comprises:
displaying a menu selection on the television;
prompting the user for ticker data preferences; and
synchronizing the ticker data preferences with the configuration parameter.

11. The method of claim 8, wherein a television set-top box stores the ticker data.

12. The method of claim 8, wherein a television adapted to process enhanced television content stores the ticker data.

13. An enhanced television content delivery system, comprising:
a data source configured to transmit ticker data;
a server coupled to the data source, the server operative to store the ticker data;
a communications link coupled to the server; and
a device coupled to the communications link and operative to receive the ticker data via the communications link, the device comprising a processor configured to filter the ticker data in accordance with a user supplied parameter.

14. The system of claim 13, wherein the server is a head-end server.

15. The system of claim 13, wherein the device is further configured to display the filtered ticker data on a television.

16. The system of claim 13, wherein the communications link is a cable television broadcast system.

17. The system of claim 13, wherein the communications link is a satellite television broadcast system.

18. The system of claim 13, wherein the device is a set-top box coupled to a television.

19. The system of claim 13, wherein the device further comprises a memory element adapted to store the ticker data.

20. The device of claim 13, wherein the processor is configured through a remote control device.

21. The device of claim 13, wherein the processor is adapted to store and run a java script program.

22. The device of claim 13, wherein the processor is configured through a keyboard.

23. An enhanced television content customization system, comprising:
means for storing ticker data received from a broadcast source;
means for presenting the ticker data to a user;
means for selectively filtering the ticker data; and
means for displaying the modified ticker data on a television.

24. The information delivery system of claim 23, wherein the means for selectively filtering the ticker data comprises a processor operative to filter the ticker data in accordance with a user specified parameter.

25. A computer-readable medium having computer-executable instructions for performing a method, the method comprising:
receiving enhanced television programming data from a video broadcaster in a substantially unmodified form;
displaying the programming data to a user as an information ticker; and
providing a user interface adapted to modify the extent that the programming data is displayed to the user.

26. In a computer system having a graphical user interface including a display and a selection device, a method of configuring enhanced television ticker information through a menu on the display, the method comprising:
receiving programming data from a broadcaster;
displaying the programming data to a user in the form of an information ticker; and
providing a user interface adapted to modify the extent that the programming data is displayed to the user.

27. An enhanced television content delivery system for delivering ticker data, comprising:
a device coupled to a communications link, the device operative to receive the ticker data via the communications link, the device comprising a processor configured to filter the ticker data in accordance with a user supplied parameter.
